(19) United States
(12) Patent Application Publication
(10) Pub. No.: US 2006/0035000 A1
(43) Pub. Date: Feb. 16, 2006

(54) Soluble coffee product having improved flavor and aroma

(76) Inventors: Paul Ralph Bunke, Cincinnati, OH (US); Athula Ekanayake, Cincinnati, OH (US); Gerhard Norbert Zehentbauer, Okeana, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/145,637

(22) Filed: Jun. 6, 2005

Related U.S. Application Data
(60) Provisional application No. 60/600,321, filed on Aug. 10, 2004.

(51) Int. Cl. A23F 5/00

(52) U.S. Cl. 426/594

(57) ABSTRACT

A soluble coffee product having an improved flavor and aroma, the coffee product comprising a soluble particulate coffee and a non-aromatized coffee oil, the coffee oil having a droplet size of from about 0.1 μm to about 25 μm.

### CROSS REFERENCE TO RELATED APPLICATIONS

This application claims the benefit of priority to U.S. Provisional Application Ser. No. 60/600,321, filed Aug. 10, 2004, which is herein incorporated by reference.

### FIELD OF THE INVENTION

The present invention relates to a soluble coffee product having an improved flavor and aroma, the coffee product comprising a soluble particulate coffee and a non-aromatized coffee oil, the coffee oil having a droplet size of from about 0.1 μm to about 25 μm when reconstituted in a coffee beverage.

### BACKGROUND OF THE INVENTION

In the world of coffee, it is generally found that pleasing flavor and aroma are particularly desirable characteristics in coffee products. Such characteristics are commonly associated with freshly brewed, high quality coffee. If a coffee product lacks a pleasing flavor and aroma, it is often perceived by the consumer to be of lesser quality. Soluble, or instant, coffee has unfortunately developed a reputation in the coffee industry, and among some consumers, as being a less desirable choice in coffee beverages because it lacks the flavor and aroma of high quality, freshly brewed coffee.

Thus, for many years, producers of soluble coffee have sought to reduce or eliminate the perceived differences between soluble coffee and freshly brewed coffee. Not surprisingly, the majority of this effort has focused on flavor and aroma improvement. Soluble coffee is commonly prepared by spray drying or freeze drying a hot water extract of a roasted coffee. This preparation process often results in a soluble coffee product which is lacking in some of the desired flavors and aromas typically associated with high quality, freshly brewed coffees. Alternately, the soluble coffee may have additional flavors and aromas considered undesirable, such as “instant” flavors or aromas. Unfortunately, this often results in the aforementioned negative perception of soluble coffee by consumers.

Many attempts to remedy this problem have been made, the most common being the incorporation of oils containing aroma constituents into the soluble coffee. The process of adding aromas to soluble coffee is known as aromatization. Aromatization generally involves capturing an aroma in a substrate, such as an oil or emulsion. See, for example, U.S. Pat. No. 5,222,364. Usually a coffee oil, or an emulsion of coffee oil and coffee extract, is used as the substrate. The aroma-containing substrate may then be sprayed on, or injected into, the soluble coffee powder prior to the coffee being packaged in containers and sealed. The theory of aromatization is that adding aromas to soluble coffee via oils provides a soluble product which more closely mimics the aroma of fresh roast and ground coffee.

While aromatization is effective for improving the aroma of soluble coffee to some extent, it is not without its difficulties. With the substrates generally used to carry out aromatization, it is often found that either the incorporation of the aroma and/or substrate is too good, or not good enough.

If the incorporation of the aroma is too good, the aroma is effectively trapped within the substrate and not sufficiently released. Thus, the consumer is unable to experience the benefit of improved aroma in the soluble coffee product when it is prepared. In an attempt to remedy this problem, recent developments suggest that aroma-enriched microemulsions of coffee oil may be used to improve the aroma of soluble coffee. See U.S. Pat. No. 5,576,044. Such microemulsions add aroma to the soluble coffee without the use of surfactants and stabilizers. However, the process of collecting the aromas and then adding them to the soluble coffee is costly when compared to manufacturing conventional soluble coffee without added aroma oils. This increased cost in the manufacturing process must then be absorbed by the consumer at the point of purchase. Additionally, the addition of aroma oils does nothing to remedy the deficient perceived flavor of the soluble coffee. It merely improves the perception of aroma when a new container of instant coffee is first opened.

On the other hand, if the incorporation of the aroma is not good enough, the aromas will volatilize before, or soon after, incorporation into the product and again, the desired benefit will be lost.

Additionally, if the incorporation of the aroma-enriched oil into the soluble coffee is not good enough, and the oils are not properly blended with the soluble coffee, there is a tendency for an unpleasant oil slick to form on the top of the product. In order to avoid the problem of oil slicks, it is known to use surfactants and stabilizers. See, for example U.S. Pat. No. 4,835,002. These surfactants and stabilizers help maintain the desired blend of oil and prevent the aforementioned formation of unsightly oil slicks. Unfortunately, such ingredients should be kept to a minimum in foodstuffs and should not be present at all if the product is considered 100% coffee. Therefore, there is still a need to develop alternate ways to improve soluble coffee products.

Therefore, there remains a need for a cost-effective, soluble coffee product, which has both improved flavor and aroma, yet remains 100% coffee.

### SUMMARY OF THE INVENTION

The present invention relates to a soluble coffee product having an improved flavor and aroma. The present inventors have surprisingly discovered a method by which to produce such a soluble coffee product without the use of aromatization. Particularly, the present invention concerns the addition of non-aromatized coffee oil to soluble coffee in such a way as to suppress the “instant” flavor of soluble coffee, such that the instant flavor is less easily or less readily perceived by the consumer. In addition, the present inventors have surprisingly and unexpectedly discovered that this addition of coffee oil to soluble coffee also suppresses the “instant” aroma typically associated with soluble coffees, thereby improving the consumer perception in a second way.

Without intending to be limited by theory, it is believed that the negative volatile flavor and aroma components typically produced during the processing of soluble coffee products preferentially diffuse into the fine coffee oil droplets created during the homogenization process of the present invention, which is explained in detail below. With these negative volatile components essentially trapped within the oil droplets, the concentration of the negative volatile components is reduced in the bulk liquid beverage, which in turn suppresses the perception of the negative flavor and aroma volatiles. Thus, by suppressing the negative volatile flavor and aroma components in the soluble coffee, the present inventors have discovered a method to improve the flavor and aroma of soluble coffee without having to add positive flavors and aromas.

Additionally, it is believed that the coffee oil may enhance the positive perceived flavor and aroma of the soluble coffee either by providing additional positive flavors and aroma to the soluble coffee, or by simply allowing positive flavors and aromas already present in the coffee to be perceived, since the negative flavors and aromas are suppressed.

As such, in one embodiment, the present invention relates to a soluble coffee product having improved flavor and aroma, the coffee product comprising:
a) a soluble coffee particulate;
b) a non-aromatized coffee oil
wherein the coffee oil has a droplet size of from about 0.1 μm to about 25 μm when reconstituted as a coffee beverage.
   In another embodiment, the present invention relates to a soluble coffee product having improved flavor and aroma, the coffee product comprising:
a) a soluble coffee particulate;
b) a non-aromatized coffee oil wherein the coffee oil source comprises Coffea Arabica var. Arabica wherein the coffee oil has a droplet size of from about 0.1 μm to about 15 μm when reconstituted as a coffee beverage and wherein the coffee product is free of added surfactants and stabilizers.

In yet another embodiment, the present invention relates to a coffee beverage comprising the present soluble coffee product.

### DETAILED DESCRIPTION OF THE INVENTION

The present invention relates to a soluble coffee product having an improved flavor and aroma, the coffee product comprising a soluble particulate coffee and a non-aromatized coffee oil, the coffee oil having a droplet size of from about 0.1 μm to about 25 μm when reconstituted in a coffee beverage. Embodiments of the invention are now described, by way of example only.

A. Definitions

As used herein, the term “brewed coffee” means a coffee beverage obtained by aqueous extraction of roasted and ground coffee using conventional brewing devices (e.g., percolators, electric percolators, drip coffee makers, automatic drip coffee makers and single serve coffee makers, for example).

As used herein, the term “coffee concentrate” means a liquid coffee extract, or a dried product of the extract, obtained by aqueous extraction of roasted and ground coffee, wherein such extract may require further processing (e.g., dilution) prior to consumption.

As used herein, the term “coffee beverage” refers to a liquid, comprising either roast and ground or soluble coffee, which may be consumed without further processing. A coffee beverage of the present invention typically is of beverage strength, which is more fully defined in the Analytic Methods section herein.

As used herein, the term “coffee extract” means a liquid extract of roasted and ground coffee, or a dried product of the extract, obtained during the manufacture of soluble (i.e., instant) coffee. Additionally, the term “coffee extract” refers to an “intermediate” liquid or solid that is subsequently processed and eventually dried to provide soluble (instant) coffee particles.

As used herein, the term “coffee oil” means the natural product obtained by solvent extraction or physical expression or extraction of the oil from coffee beans. Moreover, the term “non-aromatized coffee oil” means natural coffee oil derived by solvent extraction or physical expression of oil from coffee beans, which has not been purposely infused with additional artificial or natural flavors and/or aromas, though it may have a naturally occurring flavor and/or aroma.

As used herein, the term “comprising” means the various components, ingredients, or steps, which can be conjointly employed in practicing the present invention. Accordingly, the term “comprising” encompasses the more restrictive terms “consisting essentially of” and “consisting of”.

As used herein, the term “free of” or “free from” is used to mean that there is none of the described component in the product. For example, as described and claimed herein, the present soluble coffee product is free of added surfactants and stabilizers. Thus, the present product does not contain any added surfactants and stabilizers.

As used herein the term “homogenized” is used interchangeably with the term “homogenization” to mean the preparation of an oil-in-water emulsion of the type described herein. The oil droplets have a defined particle size and particle size distribution. An emulsion may be homogenized by any method known to one skilled in the art, such as, for example, subjecting the emulsion to high temperature and/or high pressure and/or multiple pass homogenization and/or high sheer or combinations thereof.

As used herein, the term “negative flavor and aroma” means a qualitative holistic sensory perception that is generally said to be an unpleasant or offensive character by the majority of people.

As used herein, the term “positive flavor and aroma” means a qualitative holistic sensory perception that is generally said to be of a pleasing character by the majority of people.

As used herein, the term “soluble coffee particulate” means any physical form of soluble coffee, including, but not limited to, spray dried instant coffee powders, agglomerates, freeze-dried chunks or granules, tablets and wafers.

As used herein, the term “soluble coffee product” means a coffee product comprising soluble, or instant, coffee particles which can be prepared by any process known to those skilled in the art, as well as by the process described herein. In general, soluble coffee is prepared by roasting and grinding a blend of coffee beans, extracting the roasted and ground coffee with water to form an aqueous coffee extract, and drying the extract to form the “soluble coffee product.”

As used herein, the term “substantially free” means a negligible amount and having no significant benefit. Presently, “substantially free” means less than about 0.25%, preferably less than about 0.15%, and more preferably less than about 0.1%, by weight of the soluble coffee product.

All percentages and ratios are calculated by weight unless otherwise indicated. All percentages and ratios, unless otherwise indicated, are calculated based on the total composition.

Referred to herein are trade names for components including various ingredients utilized in the present invention. The inventors herein do not intend to be limited by materials under a certain trade name. Equivalent materials (e.g., those obtained from a different source under a different name or catalog number) to those referenced to by trade name may be substituted and utilized in the compositions, kits, and methods described herein.

In the description of the invention various embodiments and/or individual features are disclosed. As will be apparent to the ordinarily skilled practitioner, all combinations of such embodiments and features are possible and can result in preferred executions of the present invention.

B. Process for Making Soluble Coffee Having Improved Flavor and Aroma

1. Extracting/Expressing the Coffee Oil

Various processes may be used to obtain oil from roast and ground coffee, however, extraction and expression are the most widely used techniques. In general, to express coffee oil from roast and ground coffee, a machine, such as, for example, a Century-One™ Expeller® Press (Anderson International Corp., Cleveland, Ohio), is used. With this particular machine, as the roast and ground coffee is fed into the machine by a screw-like device, a series of short rotating blades compress the coffee as it is pushed and pressed forward. This pressing forces the oil out of peripheral slots, which are about a few thousandths of an inch in width. A choke valve located on a discharge end of the expeller controls the back pressure (approximately 50 tons) and the expelled cake is ejected from the machine. The oil is collected and is ready for use in the next step of the process.

Similarly, in solvent extraction, coffee oil may be extracted from roast and ground coffee using numerous solvents, including, for example, pure hydrocarbons such as butane or hexane, or polar chlorinated hydrocarbons such as chloroform, Freons, carbon tetrachloride, and the like, or polar solvents such as carbon dioxide, sulfur dioxide, or ammonia. An example of a small batch scale extraction is a benchtop Soxhlet solvent extractor using hexane as the solvent with a boiling point of about 136° F. (58° C.) to extract the oil from the roasted and ground coffee. The roast & ground coffee is packed into a thimble which is placed in a soxhlet extractor and continuously extracted with hexane. Here, a fresh solvent repeatedly mixes with the coffee and exhaustively extracts coffee oils. The solvent may then be evaporated from the coffee oil under mild stripping conditions by heating the mixture to a temperature of about 203° F. (95° C.) in a rotary film evaporator under about 29 in. Hg vacuum.

It will be understood that various types of caffeinated or decaffeinated roast and ground coffees may be used as a coffee oil source herein. For example, the oil from Coffea arabica var. arabica, Coffea arabica var. bourbon and Coffea canephora can be used equally well. Indeed, any class of coffee may be used as the coffee oil source, i.e. Arabicas, Robustas, Milds, Brazils, or mixtures thereof. As an example, and not limitation, the oil can be derived from low, intermediate, or high quality coffee beans, or mixtures thereof, and preferably from high quality beans. Non-limiting examples of high quality beans include Colombian, Guatamalan, Nicaraguan and Costa Rican high grown beans. Non-limiting examples of intermediate quality beans include Mexican and Salvadorean beans, as well as washed Brazilian beans. Finally, non-limiting examples of low quality beans include robustas, low grade naturals such as Haiti XXX, Peru Natural, Salvadors, low grade Brazils, and low grade unwashed Arabicas such as the Ugandas, Indonesians, Ivory Coast, Dominican Republic, Equador, Resacas and Guatemalan TMS. While any of the foregoing coffees may be used as a source from which to extract coffee oil, preferred for use herein are arabicas, and more preferred are Colombian arabicas.

At this point, the extracted oil may optionally be deodorized using any method known to those skilled in the art, to remove any undesirable aromas and flavors produced during extraction.

Additionally, it should be noted that the coffee oil need not be freshly extracted or expressed prior to use herein. While it is preferred that the oil is used within one day of collection to ensure freshness, the oil may also be stored at about 0° F. (about −17.7° C.) in sealed containers for up to about 6 months before being used to make the present soluble coffee product. Thus, the oil may be made in advance, or purchased in bulk from a commercial supplier, and stored for later use herein.

Moreover, while it is common in the art for aromas and flavors to be added to the coffee oil at this point in the process to improve the flavor and aroma of the final soluble coffee product, the present inventors have surprisingly discovered that by using the particular process described below, an improved soluble coffee is obtained without the use of added flavors and/or aroma. Thus, the present coffee oil is non-aromatized.

2. Preparing the Soluble Coffee Extract

The following is a description of a typical countercurrent coffee extraction system and is included herein to illustrate, by way of example, this portion of the present process. The operation of such a system is well understood in the art, see, for example, Coffee Technology Volume 2 Chapter 5, Edited by R. J. Clarke and R. Macrae © Elsevier Applied Science Publishers Ltd 1987. Many modifications and variations will be apparent to those skilled in the art from the description and example that follows.

In general, to prepare a soluble coffee extract, a plurality of extraction columns filled with roast and ground coffee are connected in series by piping between the individual columns. The roast and ground coffee may be any of the aforementioned high, intermediate, or low quality coffees, or mixtures thereof. Typically, six columns are found in the countercurrent extraction system, and therefore this description is given with reference to a six-column system. However, it should be understood that more or less than six columns may be used as well. The last three columns, i.e. those containing the most spent coffee grounds, are referred to collectively as the hydrolysis columns, while the next two columns which contain coffee grounds of an intermediate degree of spentness are the extracting columns, and the first column which contains the freshest coffee grounds being referred to as the fresh extraction column. As above noted, the extraction columns are intended to be used with roast and ground coffee; however, it should be realized that it can be adapted to the extraction of whole coffee beans.

The extraction liquid, which can be either water or a dilute aqueous coffee extract obtained from another source, enters the hydrolysis columns at the lower extremity of the column and is discharged at the top of the column. The outlet line from one column is directly connected to the inlet line of the next column. The extraction liquid progresses from column to column in the series generally entering each column at the bottom and being discharged from the top. Heat exchangers are fitted in the lines between the columns immediately prior to the extraction liquid inlet to the columns. The heat exchangers can be used when required to achieve or to maintain the hydrolysis temperature, i.e. about 320° F. to about 380° F. (about 160° C. to about 193° C.), in the hydrolysis columns of the extraction system. They can also be used in the extraction columns to cool or to heat the extraction liquid to any desired extracting temperature. Each column is fitted with a means for charging the column with roast and ground coffee, for discharging the coffee from the column, and for keeping the coffee in the column during the overall extraction cycle.

In most systems, an extra column is provided in each series so that the extraction operation is not interrupted while the most nearly spent coffee column is being emptied and refilled. The extra column is a standby column which is cut into the system either slightly before or simultaneously with the removal of the most nearly spent coffee column. In the operation of the system, aqueous extract is drawn off at a reasonable draw-off ratio, usually of about 1.5:3, preferably about 1.7:2.5. As is well known to those skilled in the art, the draw-off ratio is the amount of extract withdrawn from the fresh extraction column during one cycle compared to the average weight of coffee in the individual columns.

After the extract is drawn off from the fresh extraction column, a new column containing fresh roast and ground coffee is cut into the system with the original fresh extraction column becoming the next succeeding stage, and so on to the point where the column that originally contained the most nearly spent coffee, is removed from the system. The column removed from the system is cleared of the spent coffee grounds and charged with fresh roast and ground coffee to now become the standby fresh extraction column. Typically, the extract is concentrated by heating the extract in a series of evaporators operated under vacuum to remove some of the bulk water. The extract is preferably concentrated to at least about 45%, preferably to between about 50% and 65%, solubles concentration. The soluble concentration can be determined by a typical oven-dry method where a sample of the extract is added to a small tared pan or Petri dish and the net weight recorded. The pan or dish is then placed in an oven at a temperature of about 105° C. (221° F.) for at least about 16 hours. The pan or dish is re-weighed and the dry net weight recorded. The percent soluble solids can be calculated by dividing the net weight dried by the original net weight and multiplying the quotient by 100. For example, 45 grams net weight of wet extract whose net dry weight is 23.4 grams represents a 52% soluble solids concentration (23.4/45=0.52×100=52%). The next step is to add the coffee oil to the extract.

3. Adding the Coffee Oil to the Soluble Coffee Extract

The oil can be added to a soluble coffee extract using either a batch or continuous process system. A continuous system is preferred for use herein, however, both batch and continuous systems are discussed below. For a typical batch system, coffee oil, at about 1% to about 20%, preferably about 1% to about 15%, by weight of soluble solids of the liquid extract, calculated as described above, is added to the liquid coffee extract concentrate in an agitated tank in order to disperse the oil, thereby creating a pre-emulsion. For example, about 500 pounds of extract is analyzed and found to contain 52% soluble solids by the oven-dry method described previously. This means that the extract contains about 260 pounds of soluble coffee solids (500×0.52). For oil to be added at a 1.5% level based on soluble coffee solids, 3.9 pounds of oil would need to be added (260×0.015). Once added, the dispersed oil is then pumped to a two-stage homogenizer, such as the Gaulin M3 (APV-Gaulin Co., Everett, Mass.) equipped with a standard valve and homogenized at about 5000 psig with the second stage comprising about 10% of the total pressure. The resulting homogenized liquid coffee concentrate extract is ready for optional further processing.

In a typical continuous processing system, the coffee oil is metered into the product stream using a typical metering pump. Again, the coffee oil is preferably added at about 1% to about 20%, preferably about 1% to about 15%, by weight of soluble solids of the liquid extract. Metering pumps, also known as chemical injection pumps, chemical feed pumps, proportioning pumps, and dosing pumps, are designed to deliver flow streams at adjustable, yet controlled rates. Most commonly, they are used for the proportional addition (automated or manual) of treating chemicals or other liquid additives to a variety of processes at measured rates. One example is the Bran & Luebbe plunger metering pump type D (SPX Process Equipment., Delavan Wis.). The coffee oil can be pumped directly into the liquid coffee extract flow stream that is being fed straight into the center of the generator of an in-line rotor/stator processor such as the Megatron MT 1-250 (Kinematica Inc. Newton, Mass.,). The shear generator of the Megatron typically consists of a rotor and stator, each fitted with multiple rows of teeth. The clearances between rotating and stationary rows of teeth are very small, thus generating high shear forces. The product mixture is accelerated by rotor and forced to pass through the gaps between the teeth of the stator. This results in a combination of physical effects, including turbulence, pressure fluctuations and extreme laminar and non-laminar shear forces. All of the forces combine to reduce the coffee oil droplet size to the desired dimension, creating a homogenized liquid coffee concentrate, which may then be used in the next step of the process.

Alternatively, the coffee oil can be pumped into the liquid coffee extract flow stream and further processed by an in-line rotor/stator processor, such as the Megatron MT 3-61 (Kinematica Inc. Newton, Mass.), thereby creating a pre-emulsion. The pre-emulsion is then pumped to a two-stage homogenizer, such as the Gaulin M3 (APV-Gaulin Co., Everett, Mass.). Preferably, the homogenizer is equipped with either a standard valve or a cell disruption valve. In addition, the second stage preferably comprises about 10% of the total pressure. In such a two-stage homogenizer, the second stage provides controlled back pressure ensuring the maximum efficiency of the first stage, and at the same time it minimizes the possibility of clumping and coalescence of the oil droplets in the emulsion. The pressure setting for the first stage homogenization is usually at least about 2500 psig, preferably from about 2500 psig to about 5000 psig, more preferably from about 4000 psig to about 5000 psig. The emulsion is homogenized about 1 to about 3 times (number of passes through the homogenizer), preferably about 1 time. The temperature of the emulsion ranges from about ambient to about 190° F. (88° C.), preferably between about 100° F. (38° C.) and 150° F. (66° C.). In general, as the temperature of the emulsion and the pressure at which the homogenizer is operated increases, the number of passes necessary to obtain the requisite particle size for the oil droplets decreases.

By following the above description, a liquid soluble coffee concentrate is obtained wherein the coffee oil has a droplet size in accordance with the present invention. The foregoing descriptions of homogenization are by way of example, and not limitation, such that one skilled in the art would understand a variety of other known homogenization techniques would be equally acceptable for use herein.

After combining the coffee oil and liquid coffee extract, the resulting liquid coffee concentrate may then be further processed.

4. Further Processing of the Liquid Soluble Coffee Concentrate to Obtain a Soluble Coffee Product

The liquid coffee concentrate resulting from the foregoing processing steps may be further processed. For example, the liquid coffee concentrate may be processed immediately, or it may first be blended with a non-homogenized coffee concentrate prior to further processing. It may be desirable to first blend the liquid coffee concentrate with a non-homogenized coffee concentrate. In this way, only a portion of the product is homogenized, thereby reducing the complexity and cost of the process. Regardless, there are many techniques available to transform the concentrate into a finished soluble coffee product, though spray drying is preferred. Spray drying processes, which can be used to prepare the present soluble coffee product, are known in the art and are discussed, for example, in Sivetz & Foote, COFFEE PROCESSING TECHNOLOGY, Avi Publishing Co., Westport, Conn., 1963, Vol. 1, pp. 382-513; U.S. Pat. No. 2,771,343 to Chase et al., U.S. Pat. No. 2,750,998 to Moore, and U.S. Pat. No. 2,469,553 to Hall.

In general, spray drying consists of pumping the product from a feed tank to an atomizing device located in an air disperser in the top of the drying chamber. The drying air is drawn from the atmosphere via a filter by a supply fan, and is then passed through an air heater to the air disperser. The atomized product droplets meet the hot air and evaporate, thereby cooling the air at the same time. After drying the spray in the chamber, the majority of the dried product falls to the bottom of the chamber and enters a pneumatic conveying and cooling system. The fines, which are particles having a small diameter, remain entrained in the air. Therefore, it is necessary to pass the air through cyclones to separate the fines. The fines leave the cyclone at the bottom via a locking device and enter the pneumatic system as well. The air then passes from the cyclone to the atmosphere via an exhaust fan. The two fractions of powder are then collected and combined.

At this point in the process, the dry coffee powder may be subjected to further processing, or it may be dry-blended with standard soluble coffee powder that is substantially free of coffee oil. It may be desirable to dry-blend the coffee powder with standard soluble coffee powder(s) to allow customization of the final coffee product by varying the level of coffee oil in the product. Dry blending may be carried out using a variety of equipment known in the art to be suitable for such tasks, such as, for example, a ribbon blender. In either case, whether dry-blending is used or not, it is preferred that the coffee powder comprises about 1%, preferably about 1.25%, homogenized coffee oil. For example, a commercial coffee product comprising about 1.25% added coffee oil, can be prepared on a 500 pound basis by blending about 52.08 pounds of coffee powder comprising about 12% coffee oil with about 447.92 pounds of coffee powder that is substantially free of coffee oil (52.08 lbs.×0.12=6.25 lbs oil/500 lbs total wt.=1.25% oil). Once the spray drying process, and optional dry-blending step, is finished, the soluble coffee product may then be agglomerated to improve appearance and increase solubility.

There are various methods known in the art by which to agglomerate powders, and specifically, to agglomerate coffee powders. One such example is U.S. Pat. No. 2,977,203, which describes a procedure whereby a plane of discretely arranged powder particles, which are moving in a first direction, preferably in the form of a falling curtain, are contacted by a jet of steam, thereby redirecting the particles. As the particles in the curtain enter the path of the jet of steam, they immediately become wetted. Being directed in the path of the jet of steam causes the particles to contact one another. The steam should only wet the particles, not dissolve them. One skilled in the art will understand the parameters that should be used to achieve this affect. This contact, or collision, results in a greater percentage of agglomeration. The turbulence created by the jet of steam provides a maximum opportunity for collision or contact of the wetted particles. The agglomerates formed are then typically dried by a variety of methods known in the art, such as, for example, a continuous process where the agglomerates are conveyed on a moving belt under infrared heaters.

The agglomerated particles are then preferably sorted by size. Presently, the agglomerated particles used in the present invention have a particle size of from about 0.1 mm to about 7 mm, preferably from about 0.5 mm to about 6 mm and more preferably from about 1 mm to about 5 mm. During sorting, particles that are too large are typically ground to a smaller size and then re-sorted, while particles that are too small are further agglomerated and re-sorted.

C. Soluble Coffee Product having Improved Flavor and Aroma

The soluble coffee product of the present invention has an improved flavor and aroma, when compared to typical soluble coffees on the market today. The improved flavor is a result of the foregoing processing steps, which suppress the negative “instant” coffee flavors and aroma commonly associated with soluble coffee products.

As aforementioned, without intending to be limited by theory, it is believed that the volatile negative flavor and aroma components typically produced during the processing of soluble coffee products preferentially diffuse into the fine coffee oil droplets created during the homogenization process of the present invention, as explained previously. With these negative volatile components essentially trapped within the oil droplets, the concentration of the negative volatile components is reduced in the bulk liquid beverage, which in turn suppresses the perception of the negative flavor and aroma volatiles. Thus, by suppressing the negative flavor and aroma volatiles in the soluble coffee, the present inventors have eliminated the need for adding positive flavors and aromas.

Additionally, it is also believed that the coffee oil may enhance the positive perceived flavor and aroma of the soluble coffee either by providing additional positive flavors and aroma to the soluble coffee, or by simply be allowing positive flavors and aromas already present in the coffee to be perceived, since the negative flavors and aromas are suppressed.

Furthermore, the soluble coffee product of the present invention is free of added surfactants and stabilizers, which are commonly used to maintain such oil-in-water emulsions. Therefore, the soluble coffee product of the present invention remains 100% coffee. Surprisingly, the present inventors found that, because of the size of the oil droplets formed during the homogenization process disclosed herein, the present soluble coffee product remains homogenized both while packaged and upon reconstitution. This surprising discovery results in a soluble coffee beverage which has an improved flavor and aroma when compared to other soluble coffee beverages.

Moreover, the present improved soluble coffee comprises from about 0.5% to about 3%, preferably from about 0.5% to about 1%, and more preferably from about 0.75% to about 1%, coffee oil, by weight of the final soluble coffee product. Since there is negligible loss of coffee oil during processing, the amount of coffee oil added to the extract during processing, as described above, is substantially the same amount of coffee oil in the final soluble coffee product.

Additionally, the coffee oil has a droplet size of from about 0.1 μm to about 25 μm, preferably from about 0.1 μm to about 20 μm, more preferably from about 0.1 μm to about 15 μm, and still more preferably from about 1 μm to about 10 μm when the soluble coffee product is reconstituted as a coffee beverage. It is preferred that the oil droplet size distribution within these ranges is mono-modal following an approximate normal or Gaussian curve, meaning a symmetrical or bell shaped distribution curve. It is preferred to have oil droplets within these droplet size ranges because the present inventors have discovered that further reduction in droplet size does not provide any substantial product advantage, and may add to process complexity and economic viability. Conversely, droplets larger than this range have a tendency to pool and form unsightly oil slicks on the top of the product when reconstituted. Thus, the coffee oil droplets preferably fall within the range disclosed above.

The coffee oil droplet size of the present invention may be measured with a Horiba LA-910 Particle Size Distribution Analyzer (Horiba Instruments, Inc., Irvine, Calif.) using software version 1.08. The Horiba quantitates the distribution of particles in 81 discrete channels within the overall particle size measurement range of about 0.022 μm to about 1019.5 μm (diameter of particles). This method of measuring particle size and particle size distribution is discussed in greater detail in the section entitled Analytical Methods

The present soluble coffee may be packaged in a variety of containers designed to keep the product fresh for consumers. The present inventors have unexpectedly discovered that due to the particular process disclosed herein for making the present product, the coffee oil remains homogenized with the soluble coffee. In other words, the coffee oil does not agglomerate or coalesce either before or after packaging. Moreover, the same is true after reconstitution. That is, the oil and soluble coffee remain in a homogenized state in a coffee beverage comprising the soluble coffee product, thus preventing the formation of an undesirable oil slick on the finished coffee beverage.

### EXAMPLES

### Example 1

An instant coffee is prepared on a commercial scale using known commercial processes. Roasted and ground coffee is added to a battery of commercial percolation extractors known and used in the industry for preparation of soluble coffee extracts. Six extraction columns are used and the columns are operated in a counter-current mode, i.e., the most exhausted coffee in the extraction battery is contacted first with higher feed water temperatures (up to about 180° C./356° F.) The temperature of the coffee liquor and grounds is gradually reduced to about 100° C. (212° F.) by the time the freshest grounds are contacted. The liquid coffee extract is then further concentrated using standard processes to remove bulk water, such as falling-film evaporators.

Coffee oil is then added to the coffee extract batch-wise at about a 1% level based on soluble solids of the liquid coffee extract. The batch-wise addition of the coffee oil occurs in an agitated tank in order to disperse the oil, thereby creating a pre-emulsion. The dispersed oil is then pumped to a two-stage homogenizer, such as the Gaulin M3 (APV-Gaulin Co., Everett, Mass.) equipped with a standard valve and homogenized at about 5000 psig with the second stage comprising about 10% of the total pressure. The result is a homogenized liquid coffee concentrate having a modulated flavor with reduced negative flavors and reduced negative aromas. The homogenized liquid coffee concentrate is then spray dried using conventional methods to produce a soluble coffee having improved flavor and aroma. A soluble coffee beverage is then made by mixing about 2.5 g of the soluble coffee product with about 192 g of water at a temperature of about 82° C. (180° F.). The beverage is single strength, comprises about 1.2% coffee solids and has less instant coffee flavor and aroma as compared to a soluble coffee made in a similar way without the addition of the coffee oil.

### Example 2

An instant coffee is prepared on a commercial scale using known commercial processes as described above in Example 1, except that once the liquid coffee extract is further concentrated by removing bulk water, the coffee oil is metered into the product stream using a standard metering pump at about a 1% level based on soluble solids comprising the liquid coffee extract flow stream. An in-line rotor/stator processor such as the Megatron MT 3-61 (Kinematica Inc. Newton, Mass.), is then used to disperse the oil in the liquid coffee extract concentrate creating a pre-emulsion. The dispersed oil is then pumped to a two-stage homogenizer, such as the Gaulin M3 (APV-Gaulin Co., Everett, Mass.) equipped with a standard valve. The dispersed oil is next homogenized at 5000 psig with the second stage comprising about 10% of the total pressure. The result is a homogenized liquid coffee concentrate having a modulated flavor with reduced negative flavors and aromas. The homogenized liquid coffee concentrate is then spray dried using conventional methods to produce a soluble coffee having improved flavor and aroma.

### Example 3

An instant coffee or coffee concentrate is prepared on a commercial scale using known commercial processes as described in Example 1 above, except that once the liquid coffee extract is further concentrated to remove bulk water, the coffee oil is then metered into the product stream using a standard metering pump at about a 1% level based on soluble solids comprising the liquid coffee extract flow stream. An in-line rotor/stator homogenizer, such as the Megatron MT 1-250 (Kinematica Inc. Newton, Mass.,) is then used to disperse and homogenize the oil in the liquid coffee extract concentrate. The shear generator of the Megatron consists of a rotor and stator, each fitted with multiple rows of teeth. The clearances between rotating and stationary rows of teeth are very small, generating high shear forces. The product mixture is accelerated by rotor and forced through the gaps between the teeth of the stator. This results in a combination of physical effects, including turbulence, pressure fluctuations and extreme laminar and non-laminar shear forces. All of the forces combine to reduce the coffee oil droplet size, creating an emulsion and producing a homogenized liquid coffee concentrate having a modulated flavor with reduced negative flavors, and reduced negative aromas. The homogenized liquid coffee concentrate is then spray dried using conventional methods to produce a soluble coffee having improved flavor and aroma.

### Example 4

An instant coffee is prepared on a commercial scale using known commercial processes as described in Example 1 above, except that once the liquid coffee extract is concentrated to remove bulk water, the coffee oil is metered into the product stream using a standard metering pump such as Bran & Luebbe plunger metering pump type D (SPX Process Equipment, Delavan, Wis.) at about a 15% level based on soluble solids comprising the liquid coffee extract flow stream. An in-line rotor/stator homogenizer, such as the Megatron MT 1-250 (Kinematica Inc. Newton, Mass.,) is then used to disperse and homogenize the oil in the liquid coffee extract concentrate. The shear generator of the Megatron consists of a rotor and stator, each fitted with multiple rows of teeth. The clearances between rotating and stationary rows of teeth are very small, generating high shear forces. The product mixture is accelerated by rotor and forced to pass through the gaps between the teeth of the stator. This results in a combination of physical effects, including turbulence, pressure fluctuations and extreme laminar and non-laminar shear forces. All of the forces combine to reduce the coffee oil droplet size, creating an emulsion which is a homogenized liquid coffee concentrate. This homogenized concentrate is then blended with non-homogenized coffee concentrate that is substantially free of coffee oil, at a ratio so as to produce a final soluble coffee concentrate containing about 1.5% homogenized coffee oil. The result is a homogenized liquid coffee concentrate having a modulated flavor with reduced negative flavors and reduced negative aromas. The homogenized liquid coffee concentrate is then spray dried using conventional methods to produce a soluble coffee having improved flavor and aroma.

### Example 5

An instant coffee or coffee concentrate is prepared on a commercial scale using known commercial processes as described in Example 1 above except that once the liquid coffee extract is concentrated to remove bulk water, coffee oil is then added batch-wise at about a 15% level based on soluble solids of the liquid coffee extract. The batch-wise addition of the coffee oil occurs in an agitated tank in order to disperse the oil, thereby creating a pre-emulsion. The dispersed oil (pre-emulsion) is then pumped to a two-stage homogenizer, such as the Gaulin M3 (APV-Gaulin Co., Everett, Mass.) equipped with a standard valve, and homogenized at about 5000 psig with the second stage comprising about 10% of the total pressure. The homogenized liquid coffee concentrate is then spray dried using conventional methods to produce soluble coffee Homogenized Coffee Powder (HCP). The HCP is then dry blended with typical soluble coffee powder that is substantially free of coffee oil, using a variety of equipment suitable for such tasks known in the art, e.g., a ribbon blender, to obtain a final soluble coffee powder composition comprising about 1.25% homogenized coffee oil. The blended powder is then agglomerated to maintain product homogeneity throughout the product and once packaged. Any common method known in the art is acceptable for use herein to agglomerate the coffee powders. See, for example, U.S. Pat. No. 2,977,203. The agglomerates are then dried using standard techniques, such as infrared heaters. Once dried, the soluble coffee product is ready for packaging.

### Example 6

An instant coffee is prepared on a commercial scale using known commercial processes as described in Example 1. A 30% concentrated solution of this soluble coffee is prepared by adding about 600 grams of the dry soluble coffee to about 1400 grams of water at about 71° C. (160° F.) in a large glass steel beaker to obtain a coffee concentrate. About 8.0 grams (about 1.33% of soluble coffee solids) of the coffee oil is then added to the coffee concentrate with stirring/homogenizing using a Silverson model L4RT rotor/stator (Silverson Machines Inc., East Longmeadow, Mass.) at about 5800 rpm and at a temperature of about 57° C. (135° F.). The stirring is continued for about 1.5 minutes.

A sample of the concentrate is taken and analyzed to obtain an oil droplet size distribution (Sample 1). The concentrate is then fed into an APV Gaulin Lab1000 homogenizer (APV-Gaulin Co., Everett, Mass.) and further homogenized at about 7000 psig with the second stage comprising about 10% of the total pressure in one pass. The temperature is about 46° C. (115° F.). A sample is then taken and analyzed to obtain an oil droplet size distribution (Sample 2). Next, about 500 grams of the homogenized coffee concentrate is dried to a powder in a Yamato Pulvis Model GB-22 spray drier (Yamato Scientific Co., Ltd. Tokyo, Japan). The spray drying run was conducted under the following conditions:
Inlet Temperature: 154° C. (309° F.)
Outlet temperature: 72-75° C. (161-167′)(maintained by the evaporative feed rate)
Air flow rate: 0.45M³/min.
Spray air pressure: 1.0 kg/cm²
Spray Nozzle: 2850ss internal and 67ss external orifice.

The cyclone yields about 112.92 grams of the powder, which is collected from the cyclone and placed in a jar. The dry powdered sample from the cyclone is reconstituted with hot water (about 180° F./82.2° C.) at about a 20% solids level and analyzed for its oil droplet size distribution (Sample 3). The dry powdered sample from the cyclone is then stored at ambient temperatures for about 6 months and re-analyzed for its oil droplet size distribution by reconstitution with hot water (about 180° F./82.2° C.) at about a 20% solids level (Sample 4). The results are as follows:

Oil droplet size distribution results by Horiba LA-910

| | Minimum size (μm) | Maximum size (μm) | Mean (μm) |
|---|---|---|---|
| Sample 1 | 1.318 | 15.17 | 4.694 |
| Sample 2 | 0.510 | 5.867 | 1.693 |
| Sample 3 | 1.151 | 13.25 | 3.728 |
| Sample 4 | 1.005 | 11.56 | 3.100 |

### Analytical Methods

Method for Measuring the Mean Particle Size and Particle Size Distribution of the Oil Droplets within the Beverage or Concentrate.

The size and distribution of the emulsion droplets are measured with a Horiba LA-910 Particle Size Distribution Analyzer (Horiba Instruments, Inc., Irvine, Calif.) using software version 1.08. The Horiba quantitates the distribution of particles in 81 discrete channels within the overall particle size measurement range of about 0.022 μm to about 1019.5 μm (diameter of particles).

A sample of beverage strength (about 2.4 g of soluble coffee product added to about 200 g of water at about 180° F. (82° C.)), or concentrated soluble coffee (see Example 6) is added to the mixing chamber, which is filled with distilled water, and which has the circulation and agitation on, at a setting of 3 and 4 respectively, and dispersed until the transmittance is approximately 90% (typically requires several drops of a concentrate; more for a beverage). The dispersed sample is measured for 1 min. The results are displayed using form of distribution Std., a relative refractive index of 1.18, and the volume distribution base. Other similar measurement conditions are also applicable. The mean droplet size, which is the diameter in microns of the average oil droplet, is calculated. The range of oil droplet sizes is derived from the table of results.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A soluble coffee product having improved flavor and aroma, the coffee product comprising:
a) a soluble coffee particulate;
b) a non-aromatized coffee oil
wherein the coffee oil has a droplet size of from about 0.1 μm to about 25 μm when reconstituted as a coffee beverage.

2. The soluble coffee product of claim 1 further comprising from about 0.5% to about 3% of the coffee oil, by weight of the coffee product.

3. The soluble coffee product of claim 1 wherein the coffee oil has a droplet size of from about 0.1 μm to about 20 μm when reconstituted as a coffee beverage.

4. The soluble coffee product of claim 3 further comprising from about 0.5% to about 1% of the coffee oil, by weight of the composition.

5. The soluble coffee product of claim 4 wherein a coffee oil source is selected from the group consisting of Coffea arabica var. arabica, Coffea arabica. var. bourbon, Coffea canephora and mixtures thereof.

6. The soluble coffee product of claim 5 further comprising from about 0.75% to about 1% of the coffee oil, by weight of the coffee product.

7. The soluble coffee product of claim 6 wherein the coffee oil has a droplet size of from about 0.1 μm to about 15 μm when reconstituted as a coffee beverage.

8. The soluble coffee product of claim 7 wherein the coffee oil source is Coffea arabica var. arabica.

9. The soluble coffee product of claim 8 wherein the coffee oil has a droplet size of from about 1 μm to about 10 μm when reconstituted as a coffee beverage.

10. The soluble coffee product of claim 9 wherein the coffee product is free of added surfactants and stabilizers.

11. The soluble coffee product of claim 10 wherein when the soluble coffee product is packaged in a container, the coffee particulate and coffee oil remain homogeneously mixed.

12. A soluble coffee product having improved flavor and aroma, the coffee product comprising:
a) a soluble coffee particulate;
b) a non-aromatized coffee oil wherein the coffee oil source comprises Coffea arabica var. Arabica, the coffee oil has a droplet size of from about 0.1 μm to about 15 μm when reconstituted as a coffee beverage and the coffee product is free of added surfactants and stabilizers.

13. The soluble coffee product of claim 12 further comprising from about 0.5% to about 1% of the coffee oil, by weight of the coffee product.

14. A coffee beverage comprising the soluble coffee product of claim 1.

15. The coffee beverage of claim 14 wherein the coffee oil has a droplet size of from about 0.1 μm to about 20 μm.

16. The coffee beverage of claim 15 wherein a coffee oil source is selected from the group consisting of Coffea arabica var. arabica, Coffea arabica. var. bourbon, Coffea canephora and mixtures thereof.

17. The coffee beverage of claim 16 further comprising from about 0.5% to about 1% of the coffee oil, by weight of the coffee product.

18. The coffee beverage of claim 17 wherein the coffee oil has a droplet size of from about 1 μm to about 10 μm.

19. The coffee beverage of claim 18 wherein when reconstituted, the soluble coffee particulate and the coffee oil remain homogeneously mixed.

20. The soluble coffee product of claim 19 wherein the coffee product is free of added surfactants and stabilizers.
